(19) United States
(12) Patent Application Publication
(10) Pub. No.: US 2014/0351085 A1
(43) Pub. Date: Nov. 27, 2014

(54) USING THEME-BASED ITEM GROUPINGS TO FACILITATE ITEM SELECTION

(71) Applicant: Amazon Technologies, Inc., Incline Village, NV (US)

(72) Inventors: Paul A. Kotas, Seattle, WA (US); Michael M. George, Mercer Island, WA (US)

(21) Appl. No.: 14/455,681

(22) Filed: Aug. 8, 2014

Related U.S. Application Data
(63) Continuation of application No. 10/750,331, filed on Dec. 31, 2003.

(51) Int. Cl. G06Q 30/06

(52) U.S. Cl. CPC G06Q 30/0633
USPC 705/26.8

(57) ABSTRACT

Techniques are described that allow customers and other users of an electronic marketplace to create groups of related items within the electronic marketplace, such as for customers of a Web store to create boutiques within the Web store that each reflect a specified theme. Such themed boutiques within a Web store can include various items that are available via the Web store and that each relate to the specified theme for the boutique. When other customers of the Web store are interested in items that relate to the specified theme for one of the boutiques, information regarding that boutique and/or items in that boutique can then be provided to those other customers. This abstract is provided to comply with rules requiring an abstract, and it is submitted with the intention that it will not be used to interpret or limit the scope or meaning of the claims.

### TECHNICAL FIELD

The following disclosure relates generally to techniques for identifying relevant items, and more particularly to using theme-based groupings of items to facilitate item identification and selection, such as with themed boutiques of items within a larger Web store or other electronic marketplace.

### BACKGROUND

The Internet comprises a vast number of computers and computer networks that are interconnected through communication links, with the interconnected computers exchanging information using various services such as electronic mail, FTP, Gopher, and the World Wide Web (also referred to as the “Web” or the “WWW”). The Web is a system for publishing information in which users may use a Web browser application to retrieve information (e.g., Web pages) from Web servers and then display that information.

The Web has also increasingly become a medium that is used to search for, shop for and order items (such as products and/or services) that are for purchase, rent, lease, license, trade, evaluation, sampling, etc. In many circumstances, a user can visit the Web site of a Web merchant (or a “Web store”) that sells an item, view information about the item, give an instruction to purchase the item, and provide information needed to complete the purchase (e.g., payment and shipping information). After receiving an order for one or more items, the Web merchant then fulfills the order. Some such product items may be available to be delivered electronically to a recipient (e.g., music over the Internet), while other product items (e.g., paperback books) may instead be delivered through physical distribution channels (e.g., a common carrier). Similarly, some service items can be provided electronically (e.g., providing email service), while others can be provided physically (e.g., performing cleaning services at the purchaser's house). The order fulfillment process typically used by Web merchants for product items that are to be physically provided shares similarities with other item ordering services that ship ordered items (e.g., catalog-based shopping, such as from mail-order companies).

Although shopping at Web stores can provide various advantages over other forms of shopping, interactions with conventional Web stores are not always as convenient as they might be. For example, even when a customer knows various attributes of a desired item, it can be very difficult to locate an item having those attributes. In some circumstances, it can be difficult even to identify the Web stores that might have the desired item, as there are large numbers of specialized Web stores that each offer only a small number of items, such as for a single item type (e.g., greeting cards from a greeting card Web store, pet supplies from a pet Web store, women's apparel from a women's apparel store). More generally, even after one or more appropriate Web stores have been identified that might have the desired item, it can be very difficult for the customer to determine whether those Web stores actually offer the desired item. For example, while many Web stores may categorize available items based on item type, they may not identify items based on other types of attributes that are of interest to the customer (e.g., attributes that are not specific to an item type). Furthermore, this problem of locating desired items is even more complicated when the customer lacks knowledge of specific attributes of interest for a desired item, such as when the customer instead merely knows one or more general characteristics of interest.

In addition to the problems associated with locating items having desired attributes and/or having general characteristics of interest, a variety of other problems can arise with typical Web stores. For example, Web stores do not typically allow various restrictions or conditions to be imposed for specified groups of items, such as conditions as to customers that are allowed to view information about those items and/or conditions as to customers that are allowed to shop for those items. In addition, Web stores do not typically allow third parties to offer items in conjunction with the Web store, such as to allow customers to offer used items to other customers, and the Web stores further do not typically allow various restrictions or conditions to be imposed for such items or for the customers that are allowed to offer the items.

Thus, it would be beneficial to have a more convenient approach for customers of Web stores to locate items having desired attributes and to identify items that share general characteristics. Furthermore, it would be beneficial to have a more convenient approach to be able to define restrictions and conditions related to specified groups of items available from Web stores, including for items offered by customers and other third parties.

### BRIEF DESCRIPTION OF THE DRAWINGS

FIGS. 1A-1F illustrate an example embodiment of creating customer-defined themed boutiques of related items within a Web store and of using such customer-defined themed boutiques to assist other customers in locating items of interest.

FIG. 2 illustrates an example embodiment of a customer-defined themed boutique that has a variety of associated defined conditions.

FIG. 3 is a block diagram illustrating an embodiment of a computing system for creating and using customer-defined themed boutiques of multiple items within an electronic marketplace.

FIG. 4 is a flow diagram of an embodiment of the Themed Boutique Creator routine.

FIG. 5 is a flow diagram of an embodiment of the Themed Boutique Presenter routine.

FIG. 6 is a flow diagram of an embodiment of the Themed Boutique Maintainer routine.

FIG. 7 is a flow diagram of an embodiment of the Themed Boutique Compensater routine.

### DETAILED DESCRIPTION

A software facility is described below that allows customers and other users of an electronic marketplace to create (or “define”) groups of related items within the electronic marketplace, such as to in some embodiments allow customers of a Web store electronic marketplace to create specialty boutiques within the Web store that each reflect a specified theme. Such themed boutiques within an electronic marketplace can include multiple items available via that marketplace that each relate to the specified theme for the boutique, including items of multiple item types and items that are otherwise unrelated to each other. The software facility also uses the customer-defined item groupings to assist other customers in locating items of interest, such as to provide information regarding a themed boutique and/or items in that boutique to customers that are interested in the specified theme for that boutique.

In some embodiments, themed boutiques within an electronic marketplace provide a mechanism for customers or other third-party users of the electronic marketplace (i.e., users that are not employees of the electronic marketplace or otherwise acting on behalf of the electronic marketplace) to categorize items that are available from the electronic marketplace by theme, such as based on the content of the items (e.g., a storyline of a book, a picture or words that appear on a piece of apparel or in an image, etc.), on conceptual relationships of the item to other items (e.g., associating red slippers, a scarecrow and an item that displays or includes a yellow brick road based on their shared presence in the book “The Wonderful Wizard of Oz”), on shared cultural knowledge, etc. In some such embodiments, while an item may be presented to customers as being part of or otherwise associated with a distinct themed boutique within the electronic marketplace, the shopping, ordering and order fulfillment process for the item are still performed by the electronic marketplace in the same manner as for other items available from the electronic marketplace.

In other embodiments, themed boutiques within an electronic marketplace can include items that are available directly from one or more customers (e.g., used items), whether in addition to or instead of new items that are offered from a Web merchant associated with the electronic marketplace. In some such embodiments, customers may be able to include used items in a themed boutique at an electronic marketplace only if a new copy of that item is also available via the electronic marketplace, while in other embodiments such a restriction may not exist.

More generally, the items in a themed boutique within an electronic marketplace can in some embodiments include any item available via the electronic marketplace, including items of multiple item types (e.g., products of multiple product types, such as books, CDs food products, apparel, etc. and/or services of multiple service types, such as technical support services and item repair services), items representing products and/or services, and items that are otherwise unrelated to each other. In addition, in some embodiments a themed boutique can further include one or more items that each represent other themed boutiques, thus allowing a hierarchical or other inter-relationship between some or all themed boutiques to be specified. Similarly, the types of electronic marketplaces in which such themed boutiques can be created and used can differ in various embodiments, including specialized Web stores that offer items of one or a small number of item types from a single Web merchant, general-purpose Web stores that offer items of a large number of item types from one or more Web merchants, item auction Web sites, item exchange or barter Web sites, etc.

The customer that creates a themed boutique within an electronic marketplace is in some embodiments designated as the owner of the themed boutique and given control over what items are allowed to be present in the themed boutique (e.g., other users may be restricted from adding items to the boutique or to removing items present in the boutique, or instead may be allowed to make such item changes only as specified by the boutique owner). In other embodiments, however, users other than the creator of a themed boutique may be able to add items to a themed boutique (or suggest to the themed boutique owner that the items should be added) if those other users desire that the items be associated with the theme of the boutique, such as to allow a Web merchant that participates in the electronic marketplace (e.g., by making items available via the electronic marketplace) to add items to themed boutiques. In particular, in some embodiments Web merchants that make their items available via the electronic marketplace (e.g., third-party Web merchants that are partners with the operator of the electronic marketplace) are allowed to categorize their items in various ways that include themed boutiques, which is facilitated in some such embodiments by providing a list of the themed boutiques (or of their themes) to such Web merchants.

A creator of a themed boutique can also in some embodiments specify a variety of types of administrative information for the themed boutique. For example, in some embodiments the themed boutique creator can specify one or more terms related to the theme that can be used to assist other customers in identifying the themed boutique as being of interest (e.g., by using the theme-related terms to match search queries from such customers, or by displaying lists of themes of themed boutiques to such customers). In other embodiments, additional types of descriptive information related to a themed boutique can be specified by the themed boutique creator, such as descriptions of customers and/or situations for which the items in the themed boutique are intended to be appropriate (e.g., based on interests of such customers and/or by demographic information about the customers), item delivery information that is appropriate for the items of the themed boutique, etc. If such administrative information is available for a themed boutique, the facility may in some embodiments use that information when determining when to provide information about a boutique to potential customers, as discussed in greater detail below.

In addition, the administrative information for a themed boutique can in some embodiments include a variety of types of conditions and/or restrictions related to the boutique, including conditions on who can add items to the boutique (e.g., to restrict customers that are allowed to add used items to themed boutiques, to restrict Web merchants that are allowed to add new items to boutiques, etc.), conditions on who can remove items from the boutique, conditions on who can perform other administrative or maintenance actions related to the boutique, conditions on who can receive information about the existence of the boutique and/or about the items that are included in a boutique, conditions on who can purchase or otherwise select items included in a boutique, etc. Nonetheless, in some embodiments operators of the electronic marketplace may also have the ability to perform some or all such actions, or may instead be designated as the owners of created themed boutiques in order to have control over specifying such conditions. The conditions specified for themed boutiques can take various forms, including specific identities of allowed or disallowed customers or other users, geographic restrictions on users, age restrictions on users, gender restrictions on users, restrictions based on users' affiliation with an organization or group, restrictions related to types of items or attributes of items that are allowed or disallowed in a boutique, etc. In addition, in some embodiments the themed boutiques may have conditions associated with their use and existence, such as for a temporary boutique that will terminate when specified criteria are satisfied (e.g., a termination date is reached, all of the used items added to the boutique have been selected by customers, etc.), restrictions on days and/or times when the specified boutique can be used, etc.

Moreover, in some embodiments customers are encouraged to create themed boutiques in various ways, such as by compensating the themed boutique creators with money or other forms of compensation (e.g., upon creation of a boutique with a minimum number of items and/or based on a specified theme, based on purchases or other selections of items from the boutique, etc.).

Information about themed boutiques and their items can also be provided to customers in a variety of ways. In some embodiments, customers may be able to obtain and view lists of available themed boutiques and/or a list of all of the items present in a themed boutique, while in other embodiments a customer may be presented with information about items in a themed boutique based on the presence of the items in the boutique (e.g., in response to a search request by the customer related to the theme of the boutique or instead automatically based on known interests of the customer) but without any indication to that customer of that presence.

More generally, the categorization of items by theme in the themed boutiques can assist customers that are searching for appropriate items, as can other descriptive information specified for a themed boutique. In addition to being able to identify items related to specified themes, a current customer can also use other criteria to search for themed boutiques that may be of interest, such as popularity of the themed boutique (e.g., as defined by the number of orders that have been received for items from the themed boutique) and/or usefulness of the themed boutique (e.g., based on reviews of the themed boutique by customers), whether among all customers or instead among customers with a specified demographic profile (e.g., a profile that matches the current customer). In addition, in some embodiments the facility maintains identifications of themed boutiques that are related to other themed boutiques, such as based on similarity in themes (e.g., based on themes that are synonymous, such as reflected by a thesaurus) and/or customer activity that identifies such an inter-boutique relationship. If so, related boutiques can also be provided to customers in various situations, such as if a customer's search term does not exactly match the themes of any themed boutiques but is closely related to one or more such themes, or to suggest additional related themed boutiques to a customer that has expressed interest in a themed boutique.

Various information can also be gathered and provided to users to assist in their use of themed boutiques, such as rankings of boutiques based on one or more of various measures (e.g., number of sales, customers' reviews of the usefulness or other property of the boutique, relevance to the customer, recency of changes to the boutique, etc.), aggregated and/or individual reviews of boutiques by customers that have used the boutiques, relationships between boutiques (e.g., based on similar themes, or on correlations of users' activities with and/or evaluations of multiple boutiques), etc.

As noted above, in some embodiments the techniques provided by the facility are used by an electronic marketplace to enhance the usefulness of the electronic marketplace to customers and/or partners. However, in other embodiments the techniques provided by the facility can be used in other ways, such as by an operator of the facility providing the facility's techniques to external third-parties (e.g., as a Web service to an external electronic marketplace for a fee).

Thus, themed boutiques can be created and used in a variety of ways, and provide a variety of benefits to customers and to electronic marketplaces.

For illustrative purposes, some embodiments of the software facility are described below in which themed boutiques are used with Web stores that offer items to customers from one or more Web merchants. However, those skilled in the art will appreciate that the techniques of the invention can be used in a wide variety of other situations, including with other types of items and with other types of electronic marketplaces.

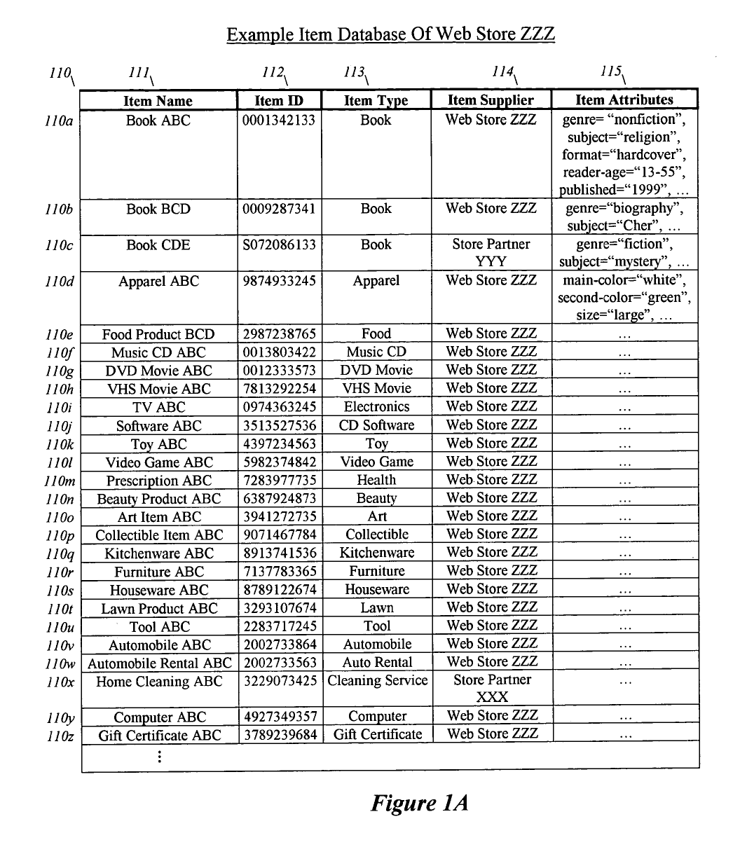

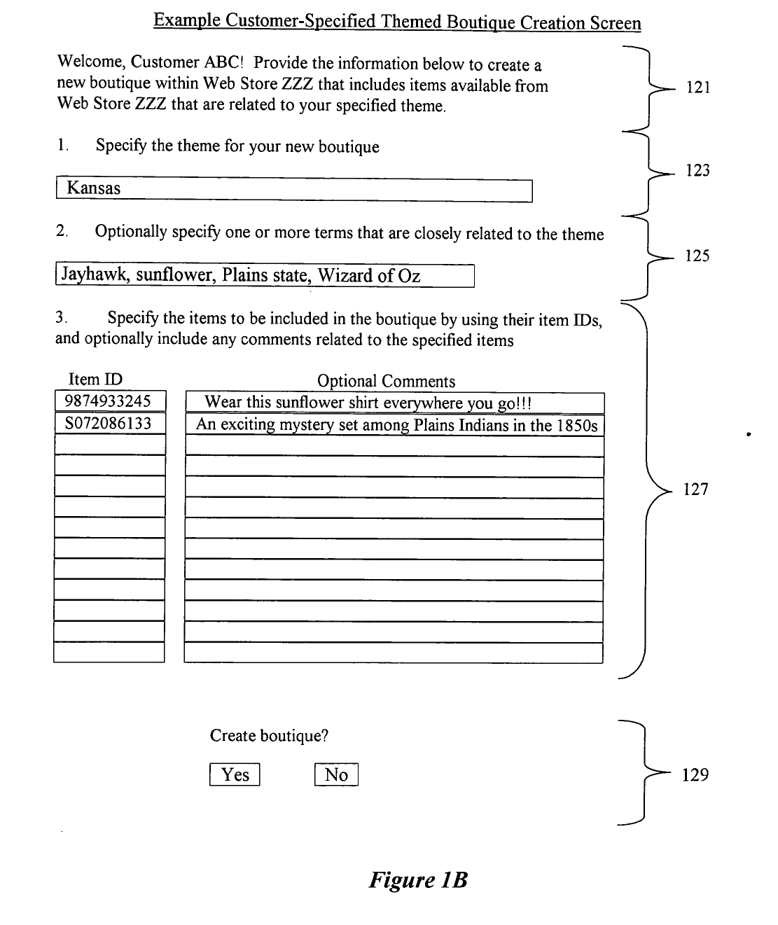

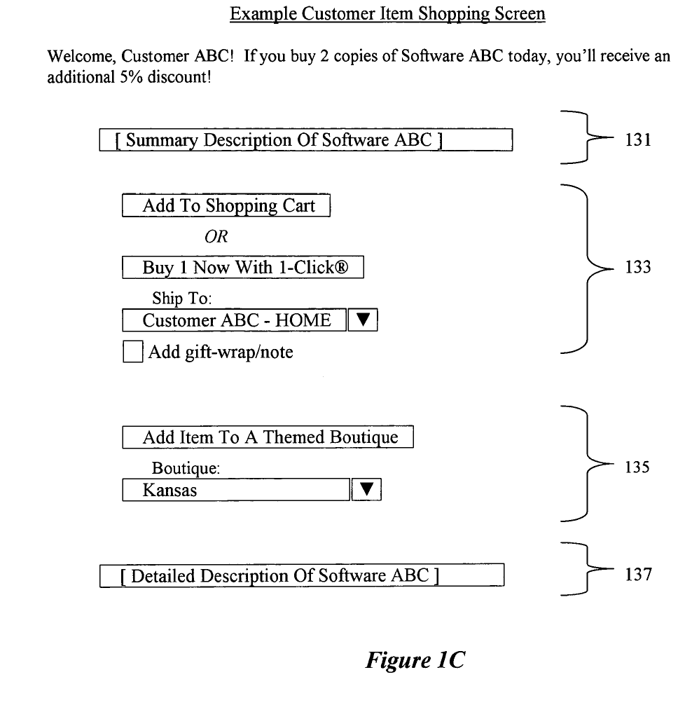

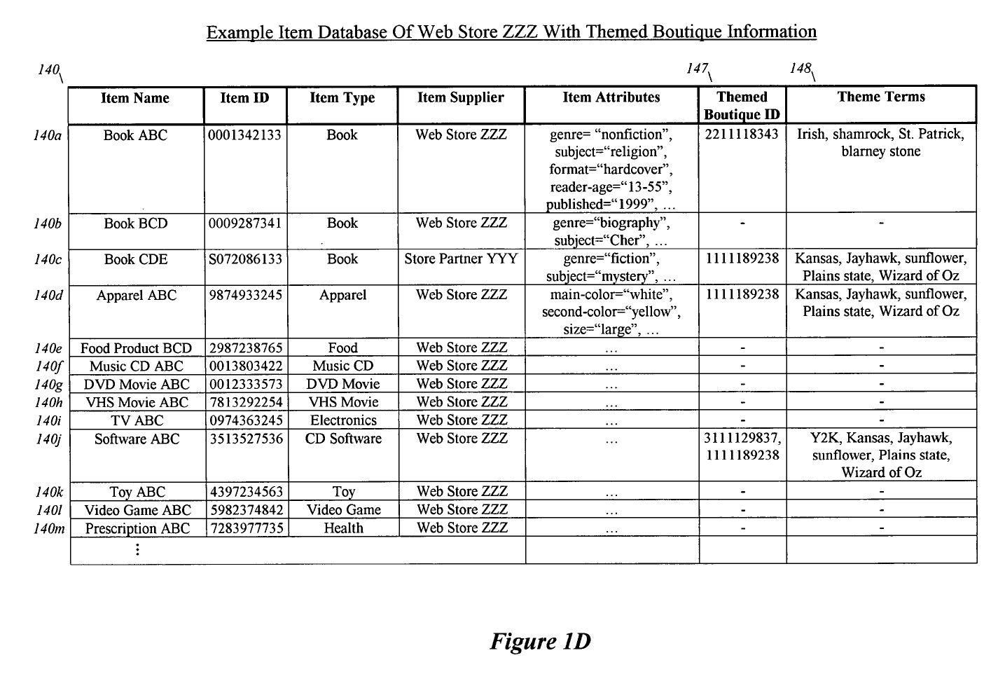

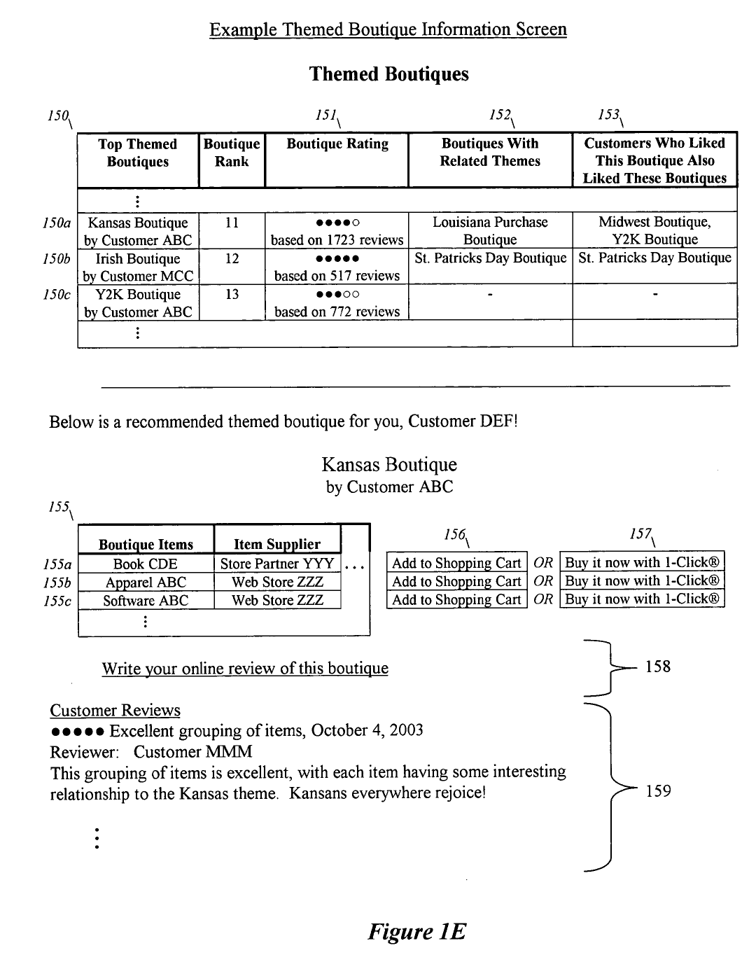

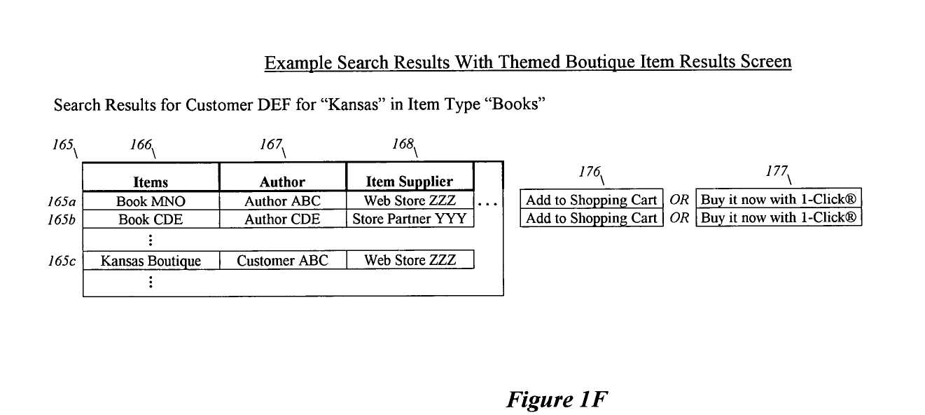

FIGS. 1A-1F illustrate various examples of creating and using customer-defined themed boutiques within a Web store. In particular, FIG. 1A illustrates an example database 110 of items that are available via an example Web Store ZZZ electronic marketplace. In this illustrated embodiment, each item has a unique item ID (as shown in column 112), an associated item type (as shown in column 113), and a variety of descriptive item attributes (as shown in column 115). The item type and item attributes may be used by Web Store ZZZ in various ways, such as to display related items to customers together (e.g., to display books together, with the books able to be further distinguished by genre or subject). In this illustrated embodiment, the values of the item attributes for an item are defined by the operator of Web Store ZZZ (e.g., by employees of the Web Store), although in other embodiments other Web merchants that sell items through Web Store ZZZ (e.g., partners of the Web store) may also supply values for some or all of the item attributes of their items. In addition, in the illustrated embodiment, the item attributes for items can vary based on the type of item. In other embodiments, different types of information may be generated and stored for items, and the information may be stored in other ways.

FIG. 1B illustrates an example interactive screen displayed to a customer to allow the customer to create a themed boutique. In particular, in the example shown, Customer ABC is provided with the illustrated Web page screen, which includes a section 121 with general instructions to the customer, a section 123 in which the customer can describe the theme for the new boutique using one or more words, and a section 127 in which the customer can specify items available from Web Store ZZZ to be included in the new themed boutique. In this illustrated embodiment, the customer can also include optional comments for some or all of the items in the themed boutique, such as to explain why the item is related to the theme and/or to provide other information of potential interest to other customers that view items in the boutique. In addition, the example boutique creation screen further includes a section 125 in which the customer can optionally specify one or more terms that are related to the theme of the boutique, such as to assist in identifying the themed boutique as relevant to other customers whose interests include items with characteristics related to the theme.

In this example embodiment, Customer ABC is creating a boutique whose theme relates to the state of Kansas, and has supplied related theme terms of “Jayhawk” (a nickname for people from Kansas), “sunflower” (the state flower), “Plains state” (a term describing a geographical area that includes Kansas), and “Wizard of Oz” (a famous literary work based in Kansas). In some embodiments, other users (e.g., employees of the operator of Web Store ZZZ) may later modify the list of theme terms, such as in this example to add an additional theme term “wheat” (a major agricultural crop of Kansas). In addition, in other embodiments the boutique creation screen may allow the customer to specify a variety of other additional types of information, such as a name for the themed boutique separate from the theme, additional information regarding the themed boutique and/or the themed boutique creator for display to other customers, and various other types of administrative information related to the boutique. Moreover, in some embodiments the creator may be able to specify additional information about the related theme terms, such as to specify a relationship of the related theme terms to the theme (e.g., the “Wizard of Oz” takes place in Kansas, while “Plains state” geographically describes Kansas). Similarly, in some embodiments the creator may be able to supply additional information to further describe the context to which the theme terms are intended to apply (e.g., the theme term “Kansas” is intended to apply to the state, not additionally or alternatively to the rock music group named “Kansas”, or that a theme term of “football” applies to the sport rather than to the item of sports equipment). After the customer has completed the initial specification of information for the new themed boutique, the customer in the illustrated embodiment can complete the boutique creation by selecting the appropriate control in section 129.

While FIG. 1B illustrates one example of a technique for a customer to create a themed boutique, such boutiques can also be created in a variety of other ways. For example, FIG. 1C illustrates an alternative technique with which a shopping customer can initiate creation of a new themed boutique and/or add items to an existing themed boutique (e.g., a themed boutique previously created by that customer, or instead any themed boutique for which the customer has authorization to add items). In particular, FIG. 1C illustrates an example shopping screen in which a current shopper Customer ABC is reviewing information related to a particular item that is available from Web Store ZZZ, with sections 131 and 137 of the example shopping screen providing various details about the item. In addition, the shopping screen includes a section 133 with which Customer ABC can select the item for potential purchase and/or immediate purchase. A variety of additional shopping-related controls may be available in other embodiments.

In addition to the shopping-related information on the shopping screen, the illustrated embodiment of the shopping screen also includes a section 135 that includes controls to allow Customer ABC to add the current item to a specified themed boutique. In some embodiments, section 135 will be displayed to a customer only when appropriate, such as when the item is not yet present in one or all of the themed boutiques available to the customer and/or when the current customer has the authorization to add the item to a themed boutique. Moreover, while not illustrated in this example embodiment, controls in such a section 135 may also allow the customer to initiate the creation of a new themed boutique that will include the current item.

FIG. 1D illustrates a revised example of the item database shown in FIG. 1A, with the revised item database 140 including additional information related to themed boutiques to which items belong. In particular, the item database 140 includes columns 147 and 148 to store various theme-related information for items, including unique IDs for each of the themed boutiques to which an item belongs and various theme terms that are associated with an item based on its inclusion in one or more themed boutiques in order to assist in categorizing the item. As discussed in greater detail below, this theme-related information can be used in a variety of ways to assist other customers in manually selecting themed boutiques of interest and/or in assisting the facility in automatically determining themed boutiques that may be of interest to a customer based on information known about interests of the customer (e.g., a search request received from the customer). In other embodiments, information such as the related theme terms may instead be stored in another table in the database, such as a table (not shown) intended to store various information related to themed boutiques. In addition, in some embodiments multiple distinct types of theme-related information may be provided for and associated with some or all of the themed boutiques that are created, such as with each type of theme-related information able to be used for a different purpose. For example, some or all themed boutiques could include theme-related information that identifies a target audience for the themed boutique, theme-related information that specifies the subject content of the theme for the themed boutique, theme-related information that specifies what items in the themed boutique can be used for, theme-related information to identify the relationships of related theme terms to the theme, theme-related information to provide additional information about the context of the theme, theme-related information to identify related themes, etc.

As shown in FIG. 1E, the information about themed boutiques can be used to assist customers in identifying relevant items in a variety of ways. For example, the upper portion of the example boutique information screen illustrated in FIG. 1E shows a variety of information about themed boutiques that are available to Customer DEF. In this illustrated embodiment, the themed boutiques are displayed in order of rank (e.g., based on popularity and/or amount of sales of items based on inclusion in the boutique), and also include information in column 151 that reflects an aggregate rating of the boutique based on reviews of the boutique by customers. Each boutique also has an indication of boutiques with related themes that is shown in column 152 (whether specified manually by users or automatically determined), as well as indications in column 153 of other boutiques that may be of interest to a customer that likes the boutique based on the preferences of other customers. In other embodiments, information about other related themed boutiques could be illustrated in other manners, such as by showing a graphical representation of the inter-relationships of themed boutiques (e.g., based on similarities in theme terms).

In addition, in the illustrated embodiment the lower portion of the example boutique information screen includes detailed information about a particular themed boutique, which in this illustrated embodiment is a boutique that was automatically selected to be recommended to the Customer DEF (e.g., an automatic recommendation based on prior activities by the customer or based on previously specified interests by the customer). In particular, table 155 includes a list of the various items that are currently present in the recommended boutique (which in this example embodiment is the Kansas Boutique created by Customer ABC), and shopping controls 156 and 157 allow Customer DEF to select one or more of those items. In this example, if Customer DEF purchases an item from the Kansas Boutique, Web Store ZZZ will process the payment and perform the ordering operations, with the item then delivered by Web Store ZZZ or a store partner as appropriate. In addition, in the illustrated embodiment the boutique information screen includes a section 158 that Customer DEF can select to provide feedback regarding the current boutique, and section 159 includes information on feedback similarly provided by other customers for this boutique. A variety of other related information and functionality can similarly be provided in other embodiments.

FIG. 1F illustrates an alternative example in which theme-related information for items can be used to assist other customers in identifying relevant items. In particular, a example search results screen is shown, with section 165 presenting search results to Customer DEF based on the customer's search for books related to the search term “Kansas”. In the illustrated embodiment, the search results include one or more items based on their inclusion in the Kansas Boutique, such as item 165b, as well as one or more items that were selected as being related to the search term “Kansas” for other reasons, such as item 165a. For example, item 165a may include the word “Kansas” in the title of the book, but its subject matter may not be very relevant to the state (e.g., the book may relate to the rock music group “Kansas”). Alternatively, item 165a may have been selected for a variety of other reasons (e.g., the author's name may be Kansas). Conversely, in this example embodiment item 165b from the Kansas Boutique does not include the word “Kansas” in its title or have other associated information that would have caused the item to have been selected as a search result but for its association with the Kansas Boutique. In addition, in the illustrated embodiment the search results also include one or more indications of themed boutiques that include items that are relevant to the search criteria, such as search result 165c for the Kansas Boutique, although in other embodiments indications of boutiques may not be presented in this manner. In addition, in some embodiments the search results may further include items based on their inclusion in themed boutiques that are related to the search terms (e.g., similar to and/or synonymous with the search terms).

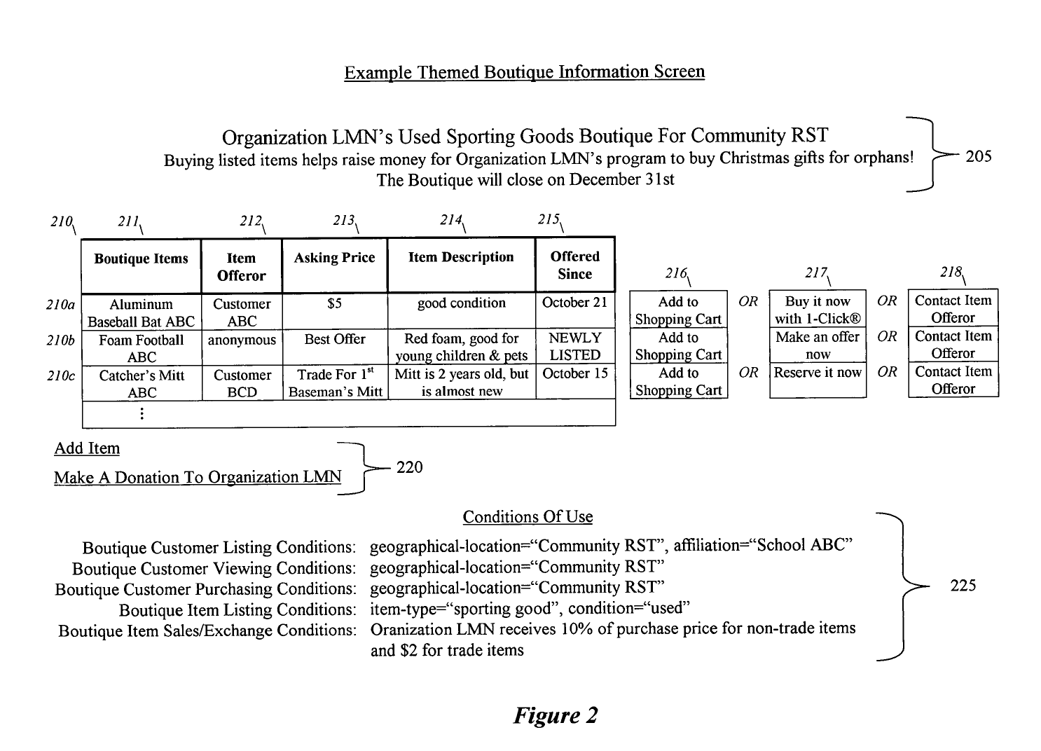

FIG. 2 illustrates an example of another themed boutique within Web Store ZZZ. In particular, while the themed Kansas Boutique created by Customer ABC included only items that were offered by Web Store ZZZ, the illustrated themed boutique 210 includes a variety of items offered by other customers but made available through Web Store ZZZ. In particular, section 205 of the screen explains to prospective customers that this themed boutique was created on behalf of Organization LMN in Community RST (e.g., people in a specified geographical area, such as a particular city or neighborhood, or another defined group of people having one or more shared attributes) to facilitate the exchange of used sporting goods between community members, as well as to raise money for a charitable program sponsored by Organization LMN. Moreover, this themed boutique will exist for only a limited time, and also includes a variety of conditions of use as shown in section 225. In this example embodiment, section 220 allows a customer to add an item to the themed boutique (assuming that the adding customer and the item to be added meet the specified conditions of use), as well as a control to allow the current customer to make a donation to the charitable program that the themed boutique benefits. In addition, various item selection controls 216-218 allow the current customer to select one or more of the items in the themed boutique, including an option 218 that allows the customer to contact the customer offering the item (e.g., by e-mail) in order to negotiate an exchange or obtain further information regarding the item. In this example embodiment, Web Store ZZZ handles payment for the themed boutique, but the customer that listed an item provides delivery of a listed item to the recipient customer. In other embodiments, these and other related tasks may be performed in other manners.

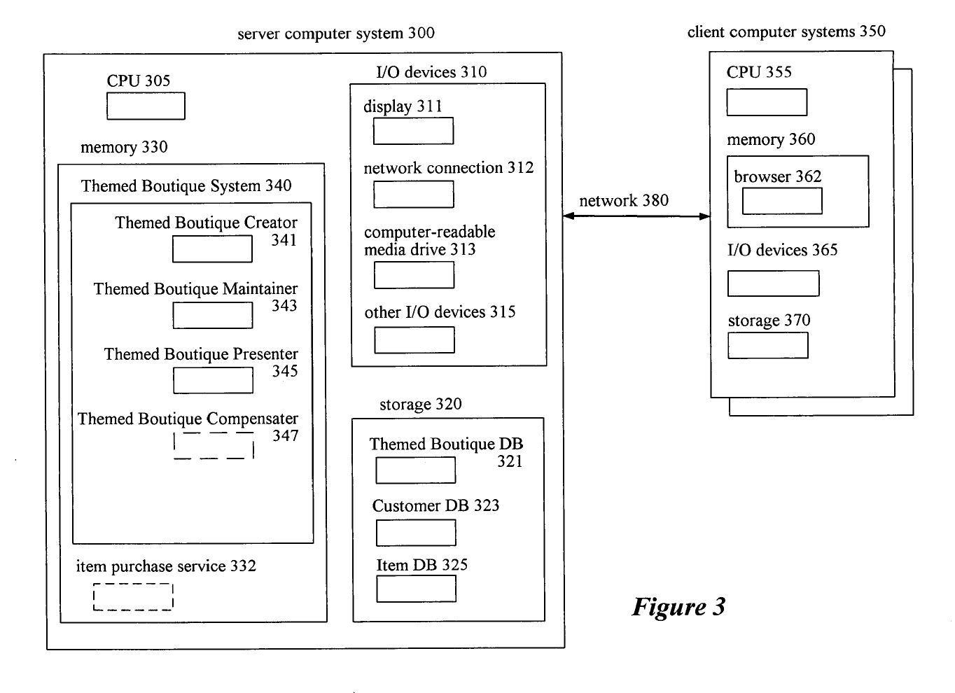

FIG. 3 is a block diagram illustrating a server computing system 300 that is suitable for executing an embodiment of a Themed Boutique system, as well as various client computing systems 350 from which users can access functionality related to themed boutiques. The server computing system includes a CPU 305, various I/O devices 310, storage 320, and memory 330. The I/O devices include a display 311, a network connection 312, a computer-readable media drive 313, and various other I/O devices 315.

An embodiment of the Themed Boutique system 340 is executing in memory, and it includes a Themed Boutique Creator component 341, a Themed Boutique Maintainer component 343, a Themed Boutique Presenter component 345, and an optional Themed Boutique Compensater component 347. In some embodiments, the Themed Boutique system will operate in conjunction with an optional item purchasing or ordering service 332 that can be executed on another computer system or in memory on the server system 300.

Users can access the Themed Boutique system in a variety of ways. For example, some users may have physical access to the server computing system. Alternatively, other users can use client computing systems to remotely access the system (e.g., via the Internet and/or the World Wide Web). Such users can use software or other functionality provided on the client computing systems, such as a browser 362 executing in memory 360, to interact with the Themed Boutique system. In addition, some or all of the Themed Boutique components may provide various feedback or other general types of information to users (e.g., in response to user requests), and this information can be presented to a user on the display 311 of the server system or on one of the I/O devices 365 of a client system. In other embodiments, non-administrative users may instead not interact directly with the Themed Boutique system, instead interacting with an item purchasing service or item selection service that provides functionality related to themed boutiques to the users via its interactions with the Themed Boutique system.

As the Themed Boutique system executes, the Themed Boutique Creator component receives requests from customers to create themed boutiques, and in response creates those themed boutiques. In particular, the Themed Boutique Creator component receives various administrative information for a themed boutique (e.g., a theme name or description, and optionally related theme terms), and also may receive indications of various items to be added to the themed boutique. After a themed boutique is initially created, various additional items can typically be added to the themed boutique by indicating the items and the themed boutique to the Themed Boutique Creator component. In addition, the Themed Boutique Creator component stores associated information for a themed boutique (including the items added to the themed boutique) in an accessible manner, such as in a Themed Boutique database 321 on storage and/or along with other item information in an Item database 325. Various information about the customer creating the themed boutique may also be added to and/or retrieved from a Customer database 323 on storage, such as for use in determining privileges related to themed boutique modification or for presentation of information about the themed boutique creator to other customers. While not illustrated here, in some embodiments an additional theme term database may also be accessible, such as to store various non-item information about the themes, including related theme terms, the relationship of related theme terms to a theme, theme context information, etc.

The Themed Boutique Maintainer component performs various maintenance actions related to existing themed boutiques, such as to ensure that conditions specified for themed boutique are enforced. For example, if a themed boutique has termination conditions or other restrictions on how and when the themed boutique can be used, the Themed Boutique Maintainer component can enforce those conditions. Similarly, when an item is removed from a themed boutique (e.g., by a customer purchasing a one-of-a-kind item in the themed boutique, such as a used item), the Themed Boutique Maintainer component can modify the stored information for the themed boutique as appropriate to remove the item or otherwise prevent the item from being displayed to other customers.

The Themed Boutique Presenter component provides information about themed boutiques and their items to customers, such as in response to search requests by the customers, in response to requests to view information about available themed boutiques, in response to requests to review the items available within a specified themed boutique, and to automatically present themed boutique information to customers as appropriate (e.g., recommendations of themed boutiques of potential interest). In some embodiments, before providing information related to a themed boutique to a customer, the Themed Boutique Presenter component first determines whether the customer is authorized to receive that information, such as based on condition information for the themed boutique in the Themed Boutique database and on customer information in the Customer database.

In some embodiments, the Themed Boutique system also includes a Themed Boutique Compensater component that assists in providing compensation to creators of themed boutiques or to other designated entities as appropriate. In particular, in some embodiments customers are given incentives to create themed boutiques by providing compensation to such customers, such as upon creation of a themed boutique and/or upon use of a themed boutique by other customers (e.g., compensation that is a percentage of revenue generated by customers shopping for items within such boutiques). In other embodiments, the themed boutique creator may designate another entity as the recipient of any such compensation, such as for charitable purposes. The compensation provided can take a variety of forms, including cash or cash equivalents, credit at the electronic marketplace within which the Themed Boutique system is in use, recognition of the creators of themed boutiques and of their boutiques by the electronic marketplace (e.g., based on displaying rankings of themed boutiques and their creators, providing displayed indications of awards given to customers based on their creation of themed boutiques and/or the use of such boutiques by other customers, etc.).

Those skilled in the art will appreciate that computing devices 300 and 350 are merely illustrative and are not intended to limit the scope of the present invention. Computing device 300 may be connected to other devices that are not illustrated, including through one or more networks such as the Internet or via the World Wide Web (WWW). More generally, a “client” or “server” may comprise any combination of hardware or software that can interact in the specified manners, including computers, network devices, internet appliances, PDAs, wireless phones, pagers, electronic organizers, television-based systems and various other consumer products that include inter-communication capabilities. In addition, the functionality provided by the illustrated system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software modules and/or components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

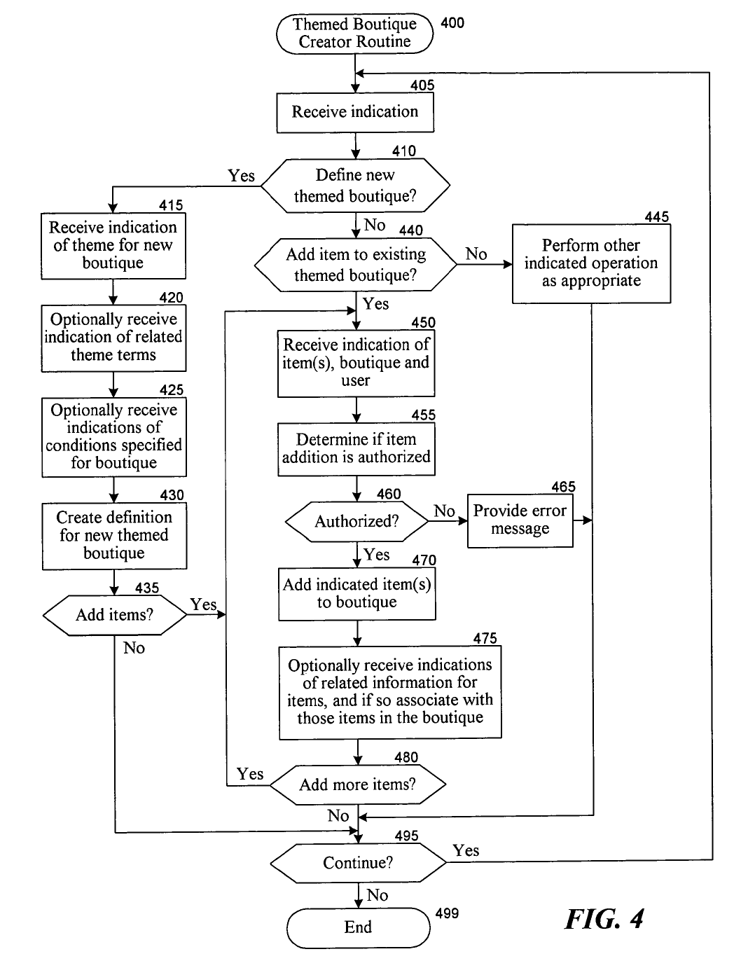

FIG. 4 is a flow diagram of an embodiment of a Themed Boutique Creator routine 400. The routine receives information related to creating themed boutiques and adding items to such boutiques, and creates and modifies themed boutiques as appropriate in response.

The routine begins at step 405 where an indication related to themed boutique creation is received. The routine continues to step 410 to determine whether the indication was to define administrative information related to a new themed boutique (e.g., a theme name or description, related theme terms, etc.). If so, the routine continues to step 415 to receive an indication of the theme for a new themed boutique to be created. In some embodiments, theme creation will only be allowed in certain circumstances, such as if the user is authorized and/or if a themed boutique with the indicated theme does not already exist, while in other embodiments multiple themed boutiques with the same theme will instead be allowed (e.g., only if such themed boutiques have different theme contexts, or instead even if the themed boutiques have the same theme contexts). In step 420, the routine then optionally receives indications of one or more related theme terms for the themed boutique. In some embodiments, the generation of such related theme terms could be facilitated in various ways, such as by providing suggestions of terms related to the theme name (e.g., based on a thesaurus). In addition, in some embodiments related theme terms can also be added for a themed boutique after its creation, such as manually by the operator of an electronic marketplace which uses the themed boutique and/or automatically based on analysis of commonalities between items in the themed boutique. After step 420, the routine continues to step 425 to optionally receive indications of one or more of various conditions and other administrative information for the boutique. The routine then continues to step 430 to create a definition for the new themed boutique based on the received information. In some embodiments, additional checking could also be performed before themed boutiques are created, such as to verify that the user creating the themed boutique is authorized to do so and/or that the theme of the new boutique or other information related to the themed boutique is appropriate.

After step 430, the routine continues to step 435 to determine whether to add items to the newly created boutique at this time, and if so continues to step 450. Alternatively, if it was instead determined in step 410 that the received indication was not to define a new themed boutique and it was then determined in step 440 that the received indication was to add an item to an existing themed boutique, the routine similarly continues to step 450. In step 450, the routine receives indications of one or more items to be added to a themed boutique and of the user specifying the item addition. In step 455, the routine then determines if the item addition is authorized based on the identity of the user and information about the item, such as based on any conditions specified for the boutique. If it is determined in step 460 that the item addition is authorized, the routine continues to step 470 to add the indicated items to the boutique. Alternatively, if the item addition is not authorized, the routine continues instead to step 465 to provide an error message. After step 470, the routine continues to step 475 to optionally receive indications of related information for the items, such as comments about the items, criteria related to selection of the items by other customers (e.g., for used items), etc., and if so the routine associates that information with those items for that themed boutique. The routine then continues to step 480 to determine whether to add more items to a themed boutique, and if so returns to step 450.

If it was instead determined in step 440 that the received indication was not to add an item to an existing themed boutique, the routine continues instead to step 445 to perform another operation as indicated if appropriate, such as to provide an indication of theme terms for one or more themed boutiques to others for their use in categorization of items, to modify the administrative information for a themed boutique, or to specify additional information about relationships between theme terms (e.g., to add new theme terms and/or new inter-relationships between terms to a theme term database). After step 445 or 465, or if it was instead determined in step 435 not to add items or in step 480 not to add more items, the routine continues to step 495 to determine whether to continue. If so, the routine returns to step 405, and if not the routine continues to step 499 and ends.

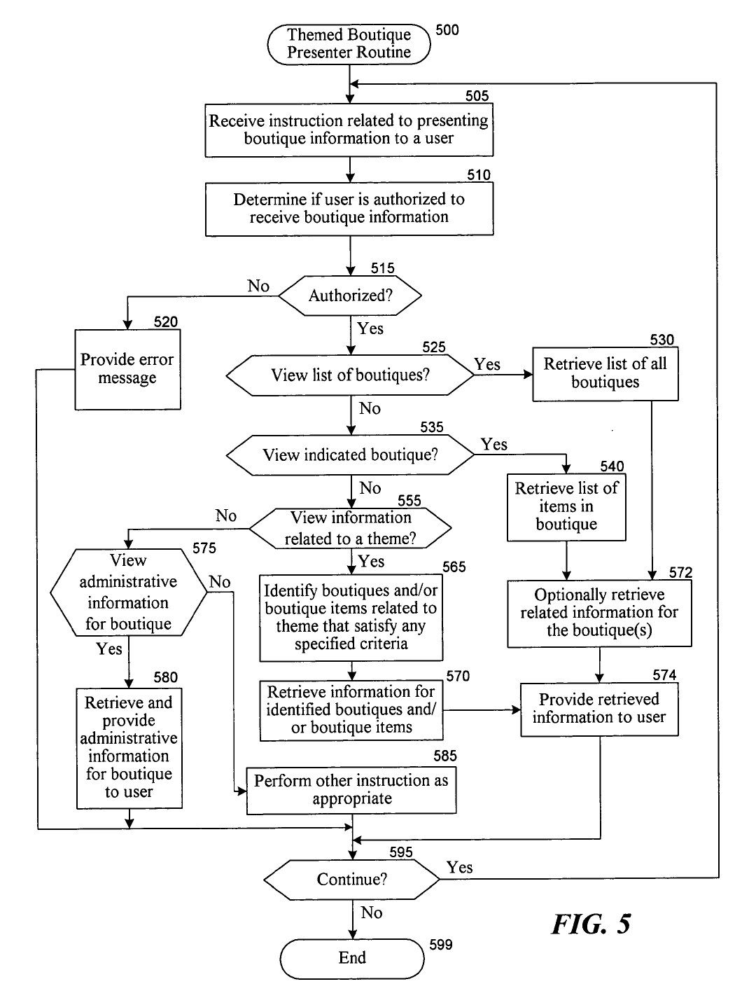

FIG. 5 is a flow diagram of an embodiment of a Themed Boutique Presenter routine 500. The routine provides information about existing themed boutiques to various customers as appropriate.

The routine begins at step 505, where an instruction is received related to presenting boutique information to a user. In step 510, the routine determines if the user is authorized to receive the indicated boutique information. If in step 515 the user is not authorized, the routine continues to step 520 to provide an error message as appropriate. If the user is instead determined to be authorized, the routine continues to step 525 to determine whether the instruction was to provide a list of themed boutiques to the user. If so, the routine continues to step 530 to retrieve a list of all themed boutiques, and then continues to step 572 to optionally retrieve related information for the boutique, such as administrative information, rating information, reviews by other customers, recommendations related to the boutique, etc. However, if it was instead determined in step 525 that the received instruction was not to provide a list of boutiques, the routine continues instead to step 535 to determine whether the instruction was to provide information about an indicated themed boutique (e.g., such as based on an ID for a themed boutique, on a combination of a theme term and a context, such as “Kansas” and “state”, on a unique themed boutique name, etc.). If so, the routine continues to step 540 to retrieve a list of items in the boutique, and then continues to step 572.

If it was instead determined in step 535 that the received instruction was not to view information about an indicated boutique, the routine continues instead to step 555 to determine whether the instruction is to view information related to a theme, such as in response to a search or browse request. If so, the routine continues to step 565 to identify themed boutiques and/or items in themed boutiques that are related to the indicated theme and that further satisfy any other specified criteria (e.g., only items of a particular item type, or only items from a themed boutique whose theme terms correspond to an indicated theme context). After step 565, the routine continues to step 570 to retrieve information for the identified themed boutiques and/or themed boutique items. After step 570 or 572, the routine continues to step 574 to provide the retrieved information to the user, such as based on a specified manner of presentation and/or in accordance with any known preferences of the user.

If it was instead determined in step 555 that the received instruction was not related to viewing information related to a theme, the routine continues to step 575 to determine whether the received instruction was to view administrative information for a boutique. If so, the routine continues to step 580 to retrieve the requested administrative information for the boutique and to provide that information to the user. If it was instead determined in step 575 that the received instruction was not to view administrative information for a boutique, the routine continues to step 585 to perform another instruction as indicated if appropriate. For example, in some embodiments users may be able to request and receive information about inter-relationships between themed boutiques and/or between theme terms. After steps 520, 574, 580, or 585, the routine continues to step 595 to determine whether to continue. If so, the routine returns to step 505, and if not the routine continues to step 599 and ends.

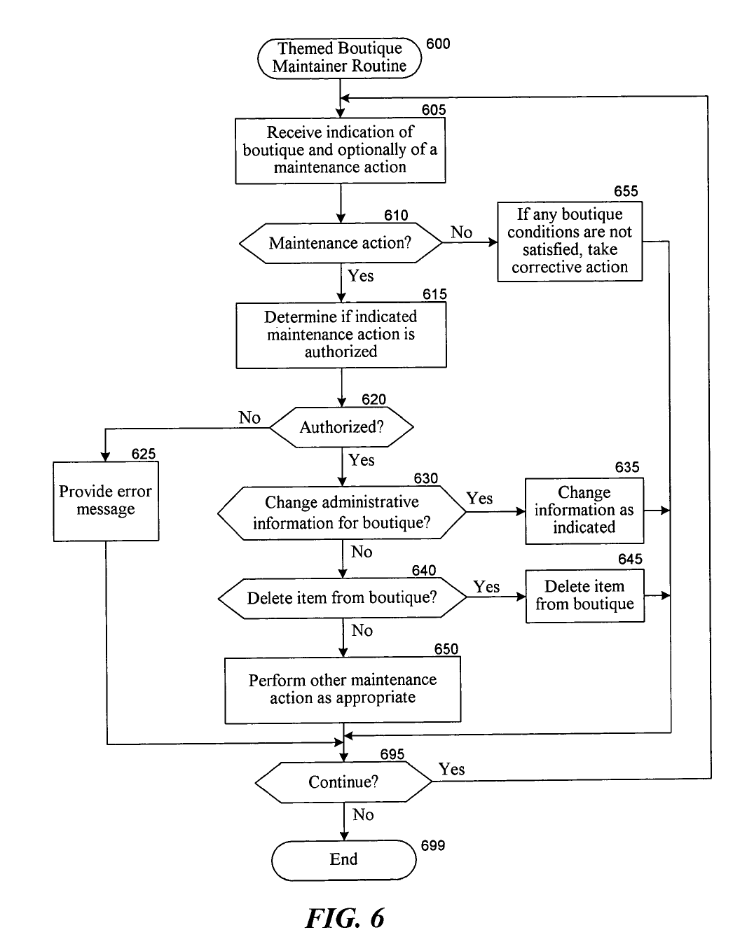

FIG. 6 is a flow diagram of an embodiment of a Themed Boutique Maintainer routine 600. The routine performs various administrative operations with respect to maintaining existing themed boutiques.

The routine begins at step 605 where an indication is received of a themed boutique and optionally of a maintenance action for the themed boutique (e.g., to change administrative information for a themed boutique). The routine continues to step 610 to determine whether a maintenance action was specified, and if not continues to step 655 to determine whether any boutique conditions are currently not satisfied and/or if any other corrective action is needed for the boutique, and if so takes such corrective action. If it was instead determined in step 610 that a maintenance action was specified, the routine continues in step 615 to determine if the indicated maintenance action is authorized, such as based on specified conditions for the boutique and the user specifying the maintenance action. If in step 620 the maintenance action is not authorized, the routine continues in step 625 to provide an error message. Otherwise, the routine continues in step 630 to determine whether the maintenance action is to change administrative information for the themed boutique, and if so continues in step 635 to change the administrative information as indicated.

If it was instead determined in step 630 that the maintenance action was not to change administrative information, the routine continues to step 640 to determine whether the maintenance action is to delete an item from the boutique, and if so continues to step 645 to delete the item from the boutique. In some embodiments, deleting an item from the boutique may merely involve modifying information stored with respect to that item, while in other situations all information about the item may be removed, such as if the item was available only via the themed boutique (e.g., for a used item). If it was instead determined in step 640 that the maintenance action was not to delete an item, the routine continues to step 650 to perform another indicated maintenance action as appropriate. After steps 625, 635, 645, 650 or 655, the routine continues to step 695 to determine whether to continue. If so, the routine returns to step 605, and otherwise the routine continues to step 699 and ends.

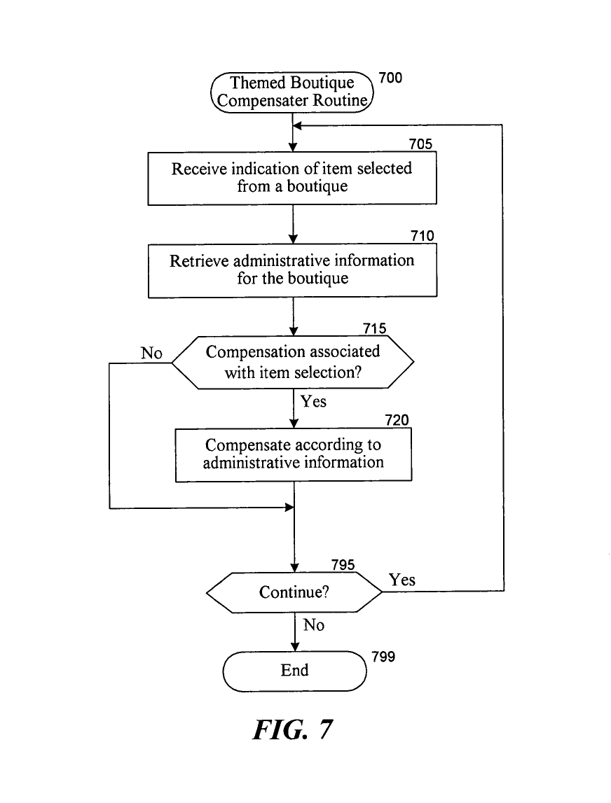

FIG. 7 is a flow diagram of a Themed Boutique Compensater routine 700. The routine in the illustrated embodiment provides compensation to a customer that created a themed boutique based on the usage of the themed boutique by other customers, although in other embodiments compensation can be provided based on other criteria.

In the illustrated embodiment, the routine begins at step 705 where an indication is received of an item that was selected from a themed boutique by a customer. The routine continues to step 710 to retrieve administrative information for the boutique, and in step 715 determines whether compensation is associated with the item selection based on the retrieved administrative information. If so, the routine continues to step 720 to compensate the themed boutique creator or other specified entity according to the administrative information. After step 720, or if it was instead determined in step 715 that compensation was not associated with the item selection, the routine continues to step 795 to determine whether to continue. If so, the routine returns to step 705, and if not the routine continues to step 799 and ends.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

1-50. (canceled)

51. A computer-implemented method comprising:
creating, by a configured computing system operated by an electronic marketplace offering a plurality of products to a plurality of customers, a boutique within the electronic marketplace, the created boutique having one or more specified criteria that restrict access to the created boutique to a subset of the plurality of customers;
determining, by the configured computing system, that multiple indicated customers are allowed by the one or more specified criteria to add multiple specified products to the created boutique, and adding the multiple products to the created boutique in response to indications from the multiple indicated customers;
receiving, by the configured computing system, a request from a first customer to perform a specified activity for the created boutique involving one or more products of the multiple products added to the created boutique; and
after determining that the first customer is allowed by the one or more specified criteria to perform the specified activity, initiating, by the configured computing system, performance of the specified activity for the first customer.

52. The computer-implemented method of claim 51 wherein the creating of the boutique is initiated by one of the plurality of customers, wherein the one or more specified criteria include one or more geographical areas specified by the one customer, and wherein the subset of the plurality of customers are customers located in the one or more geographical areas.

53. The computer-implemented method of claim 51 wherein the creating of the boutique is initiated by one of the plurality of customers, wherein the one or more specified criteria include an affiliation with one or more defined groups specified by the one customer, and wherein the subset of the plurality of customers are customers who are affiliated with the one or more defined groups.

54. The computer-implemented method of claim 51 wherein the creating of the boutique is initiated by one of the plurality of customers, wherein the one or more specified criteria include one or more ages specified by the one customer, and wherein the subset of the plurality of customers are customers who have ages matching at least one of the specified one or more ages.

55. The computer-implemented method of claim 51 wherein the one or more specified criteria include one or more conditions specified by at least one customer about which customers are allowed to add products to the created boutique, and wherein the determining that the multiple indicated customers are allowed to add the multiple specified products to the created boutique includes verifying that the indicated customers satisfy the one or more conditions.

56. The computer-implemented method of claim 51 wherein the one or more specified criteria include one or more conditions specified by at least one customer about which customers are allowed to purchase products from the created boutique, wherein the request from the first customer is to purchase the one or more products added to the created boutique, and wherein the determining that the first customer is allowed by the one or more specified criteria to perform the specified activity includes verifying that the first customer satisfies the one or more conditions.

57. The computer-implemented method of claim 51 wherein the one or more specified criteria include one or more conditions specified by at least one customer about which customers are allowed to view which products have been added to the created boutique, wherein the request from the first customer is to view information about the one or more products added to the created boutique, and wherein the determining that the first customer is allowed by the one or more specified criteria to perform the specified activity includes verifying that the first customer satisfies the one or more conditions.

58. The computer-implemented method of claim 51 wherein the one or more specified criteria include one or more conditions specified by at least one customer about which customers are allowed to obtain information about existence of the created boutique, wherein the request from the first customer includes identifying that the one or more products are part of the created boutique, and wherein the determining that the first customer is allowed by the one or more specified criteria to perform the specified activity includes verifying that the first customer satisfies the one or more conditions.

59. The computer-implemented method of claim 51 wherein the creating of the boutique is initiated by one of the plurality of customers, wherein the one or more specified criteria further include a restriction specified by the one customer that all products added to the created boutique be used products provided by customers of the subset, and wherein the determining that the multiple indicated customers are allowed to add the multiple specified products to the created boutique includes verifying that the multiple specified products are used products.

60. The computer-implemented method of claim 59 wherein the request from the first customer is to purchase the one or more products added to the created boutique, wherein the one or more products were added to the created boutique by one or more second customers of the subset, and wherein the initiating performance of the specified activity for the first customer includes:
obtaining, by the configured computing system, payment from the first customer for the one or more products; and
initiating delivery of the one or more products from the one or more second customers to the first customer.

61. The computer-implemented method of claim 59 wherein the request from the first customer is to purchase the one or more products added to the created boutique, and wherein the initiating performance of the specified activity for the first customer includes:
obtaining, by the configured computing system, payment from the first customer for the one or more products; and
providing, by the configured computing system, at least some of the obtained payment to a charitable organization associated with the created boutique.

62. The computer-implemented method of claim 51 wherein the one or more specified criteria include a restriction that all products added to the created boutique be copies of the plurality of products offered by the electronic marketplace, and wherein the determining that the multiple indicated customers are allowed to add the multiple specified products to the created boutique includes verifying that each of the multiple specified products is a copy of one of the plurality of products.

63. The computer-implemented method of claim 51 wherein the one or more specified criteria include a restriction specified by at least one customer that all products added to the created boutique include one or more attributes, and wherein the determining that the multiple indicated customers are allowed to add the multiple specified products to the created boutique includes verifying that each of the multiple specified products includes the one or more attributes.

64. The computer-implemented method of claim 51 wherein the one or more specified criteria further include termination conditions for the created boutique, and wherein the method further comprises terminating, by the configured computing system, operation of the created boutique when the termination conditions are satisfied.

65. The computer-implemented of claim 51 wherein the creating of the boutique is initiated by one of the plurality of customers and includes storing information about the one or more specified criteria being associated with the created boutique, wherein the one or more specified criteria include a theme that is specified by the one customer for products added to the created boutique and that corresponds to an indicated organization or community, and wherein the adding of the multiple products to the created boutique includes storing information about the multiple products being associated with the specified theme of the created boutique.

66. A non-transitory computer-readable medium having stored contents including instructions that, when executed, configure a computing system to at least:
create a boutique within an electronic marketplace, the created boutique having one or more specified criteria that restrict access to the created boutique to a subset of customers of the electronic marketplace; and
enforce the one or more specified criteria while operating the created boutique based at least in part on:
determining that indicated customers are allowed by the one or more specified criteria to add multiple specified products to the created boutique, and adding the multiple products to the created boutique; and
determining that a first customer is allowed by the one or more specified criteria to perform a specified activity for the created boutique involving one or more products of the multiple products added to the created boutique, and initiating performance of the specified activity for the first customer.

67. The non-transitory computer-readable medium of claim 66 wherein the creating of the boutique is initiated by one of the customers of the electronic marketplace, and wherein the one or more specified criteria include restrictions that products added to the created boutique be used products and that customers who purchase products added to the created boutique be located in one or more geographical areas specified by the one customer.

68. The non-transitory computer-readable medium of claim 66 wherein the creating of the boutique is initiated by one of the customers of the electronic marketplace, and wherein the one or more specified criteria include restrictions that products added to the created boutique be used products and that customers who purchase products added to the created boutique have an affiliation with one or more defined groups specified by the one customer.

69. The non-transitory computer-readable medium of claim 66 wherein the one or more specified criteria include one or more conditions about which customers are allowed to add products to the created boutique, and wherein the determining that the indicated customers are allowed to add the multiple specified products to the created boutique is performed in response to instructions from the indicated customers to add the multiple specified products to the created boutique and includes verifying that the indicated customers satisfy the one or more conditions.

70. The non-transitory computer-readable medium of claim 66 wherein the one or more specified criteria include one or more conditions about which customers are allowed to purchase products from the created boutique, wherein the specified activity of the first customer is to purchase the one or more products added to the created boutique, and wherein the determining that the first customer is allowed by the one or more specified criteria to perform the specified activity includes verifying that the first customer satisfies the one or more conditions.

71. A computing system comprising:
a hardware processor; and
a memory including instructions that, when executed by the hardware processor, at least:
create a boutique within an electronic marketplace, the created boutique having one or more specified criteria that restrict access to the created boutique to a subset of customers of the electronic marketplace;
determine that one or more indicated customers are allowed by the one or more specified criteria to add multiple specified products to the created boutique, and add the multiple products to the created boutique in response to one or more indications from the one or more indicated customers;
determine that a first customer is allowed by the one or more specified criteria to perform a specified activity for the created boutique involving one or more products of the multiple products added to the created boutique; and
initiate performance of the specified activity for the first customer.

72. The computing system of claim 71 wherein the creating of the boutique is initiated by one of the customers of the electronic marketplace, and wherein the one or more specified criteria include a restriction that products added to the created boutique be used products provided by customers located in one or more geographical areas specified by the one customer.

73. The computing system of claim 71 wherein the creating of the boutique is initiated by one of the customers of the electronic marketplace, and wherein the one or more specified criteria include a restriction that products added to the created boutique be used products provided by customers who have an affiliation with one or more defined groups specified by the one customer.

74. The computing system of claim 71 wherein the one or more specified criteria include one or more conditions about which customers are allowed to add products to the created boutique, and wherein the determining that the one or more indicated customers are allowed to add the multiple specified products to the created boutique is performed in response to instructions from the one or more indicated customers to add the multiple specified products to the created boutique and includes verifying that the one or more indicated customers satisfy the one or more conditions.

75. The computing system of claim 71 wherein the one or more specified criteria include one or more conditions about which customers are allowed to purchase products from the created boutique, wherein the specified activity of the first customer is to purchase the one or more products added to the created boutique, and wherein the determining that the first customer is allowed by the one or more specified criteria to perform the specified activity includes verifying that the first customer satisfies the one or more conditions.
